(19) United States
(12) Patent Application Publication
(10) Pub. No.: US 2004/0049742 A1
(43) Pub. Date: Mar. 11, 2004

(54) Document creation support system

(75) Inventors: Yoshiakira Yokoyama, Osaka (JP); Shinobu Kanda, Osaka (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD

(21) Appl. No.: 10/648,262

(22) Filed: Aug. 27, 2003

(30) Foreign Application Priority Data
Aug. 3, 2002 (JP) P2002-253258

(51) Int. Cl. G06F 17/00

(52) U.S. Cl. 715/530

(57) ABSTRACT

A document creation support system having: an input interface unit for inputting information (parameter information) of a description change part in accordance with specifications by a designer; a variable converting unit for generating a variable from the information input to the input interface unit; an entity referring unit for defining the variable generated by the variable converting unit; a database unit; a synthesizing unit for referring to a character train in a template database part, referring to a variable-content database part in the database unit on the basis of the definition of the entity referring unit and performing synthesis, and a function of outputting a manual by the synthesizing unit.

### BACKGROUND OF THE INVENTION

The present invention relates to a document creation support system for supporting creation of a structured document which is created and edited on a computer. The system is particularly suitable for creating instruction manuals for various products.

One of methods of creating a manual by synthesis using a structured document is a document creation support system which employs synthesis of components. A document is divided into components and the components are stored in a database. At the time of creating a document, the components are designated and retrieved from the database, and documents of the components are extracted and combined, thereby creating a target document. When the type of a document is predesignated, the structure is retrieved from the database and displayed on a screen. A document is automatically created in a predesignated output format. Specifically, data of a manual is handled as a structured document and held as a database, and the structured documents are synthesized, thereby facilitating creation of a desired manual.

In this case, however, only a document in a format including predetermined items can be created. A document in which attention is paid to a small change in items or a change in connection of documents cannot be created. Although components can be retrieved and extracted, with respect to variations according to documents, application of words according to the situations, exact calculation in words, and the like are impossible. That is, it is difficult to flexibly create a document for the reason that a pattern for retrieving and extracting data is fixed.

### SUMMARY OF THE INVENTION

A main object of the invention is, therefore, to provide a very flexible document creation support system which can flexibly deal with a variable change in specifications.

To achieve the object, the invention provides the document creation support system with the following means. Specifically, a database unit is constructed by a template database part and a variable-content database part. The template database part includes document information of a template document in which a character train variable and a data variable with a tag are embedded. The variable-content database part includes a group of database components with tags. When the character train variable is defined, one replaced by the definition of the character train variable is a relatively simple word or the like. In contrast, when the database component with a tag is defined, one replaced by the definition of the data variable with the tag is a structured document, table, or figure having a combination of a plurality of words. Therefore, the database component with a tag has a structure more complicated as compared to the structure of the character train variable.

The document creation support system according to the invention has, together with the database part, components which are an input interface unit, a variable converting unit, an entity referring unit, and a synthesizing unit each having the following functions.

The input interface unit is used to input parameter information instructing a description change part in a target document with respect to the template document.

The variable converting unit defines the character train variable and the data variable with a tag on the basis of the parameter information which is input in the input interface unit.

The entity referring unit searches the template database part and the variable-content database part in the database unit on the basis of the character train variable and the data variable with a tag. By searching the template database part, the template document is obtained. By searching the variable-content database part, a database component with a tag corresponding to the definition of the data variable with a tag is obtained.

The synthesizing unit instantiates the character train variable embedded in the retrieved template document with the definition of the character train variable, and instantiates the data variable with a tag buried in the template document with the retrieved database component with a tag. The synthesizing unit combines the definition of the character train variable and the database component with a tag which have been instantiated in the template document with the template document, thereby generating a target document, and outputs the target document.

The configuration of the invention has the following effects. Since the database unit is constructed by the combination of the template database part and the variable-content database part, unlike the conventional technique, it is unnecessary to set all of document elements as components. Therefore, the database can be simplified. The invention can flexibly deal with not only a simple character train, but also data with a tag such as a document, a table, or a figure having a more complicated structure. Consequently, it is necessary only to input parameter information as information of a part in which description is to be changed in association with a change in specifications. According to the invention, the document creation support can be performed efficiently.

More preferably, the database component with a tag in the variable-content database part has a nested structure in which a character train variable and a data variable with a tag are embedded.

Consequently, the invention can flexibly deal with creation of a document having a structure which is further more complicated. Thus, efficiency of the document creation can be further increased.

The foregoing and other aspects will become apparent from the following description of the invention when considered in conjunction with the accompanying drawing figures.

### BRIEF DESCRIPTION OF THE DRAWING FIGURES

FIG. 1 is a block diagram showing a general configuration of a document creation support system in an embodiment of the invention.

FIG. 2 is a configuration diagram showing an example of a display screen of an input interface unit in the embodiment of the invention.

FIG. 3 is a configuration diagram showing an example of a table processed by a variable converting unit in the embodiment of the invention.

FIG. 4 is a diagram illustrating an example of data processed by an entity referring unit in the embodiment of the invention.

FIG. 5 is a diagram illustrating an example of data processed by a template database part in the embodiment of the invention.

FIG. 6 is a diagram illustrating an example of data of a database component with a tag processed by a variable-content database part in the embodiment of the invention.

FIG. 7 is a diagram illustrating an example of a manual which is output in the embodiment of the invention.

FIG. 8 is a flowchart showing operations of automatically creating a manual in the embodiment of the invention.

In all these figures, like components are indicated by the same numerals.

### DETAILED DESCRIPTION

A preferred embodiment of a document creation support system of the invention is described below with reference to the drawings.

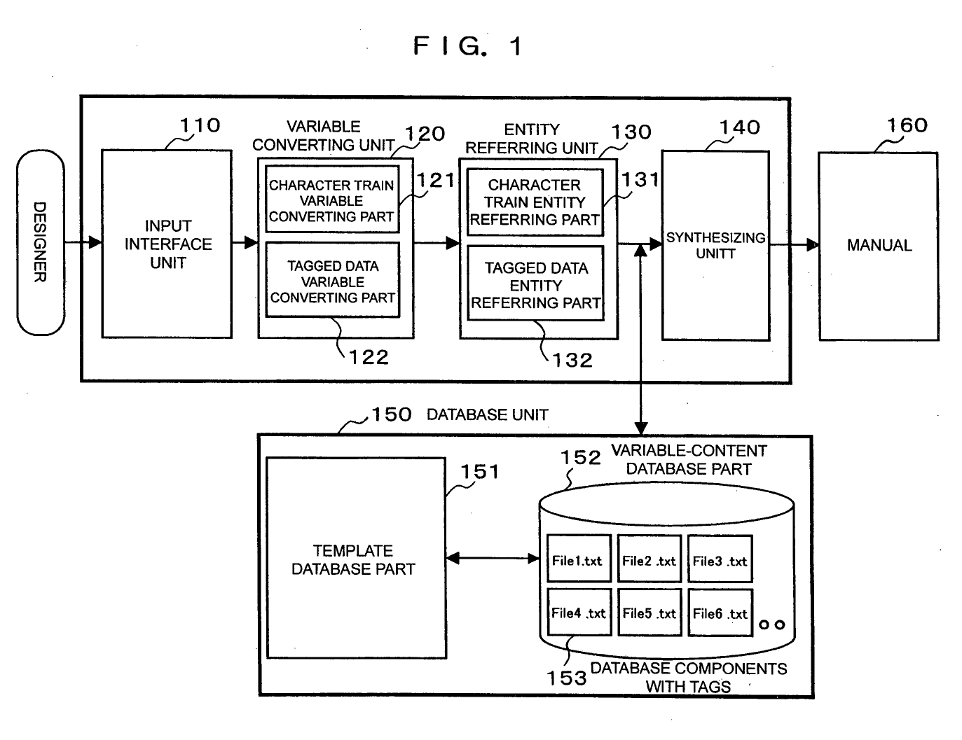

FIG. 1 is a block diagram showing a general configuration of the document creation support system in the embodiment of the invention. The document creation support system is constructed by an input interface unit 110, a variable converting unit 120, an entity referring unit 130, a synthesizing unit 140, and a database unit 150.

The input interface unit 110 has the function of transferring parameter information which is entered by a designer to the variable converting unit 120. The parameter information is information for instructing a description change part according to specifications and has the function of selecting and expanding.

The variable converting unit 120 is constructed by a character train variable converting part 121 and a tagged data variable converting part 122. The variable converting unit 120 generates definition of a variable of the entity referring unit 130 on the basis of the parameter information received from the input interface unit 110.

The entity referring unit 130 is constructed by a character train entity referring part 131 and a tagged data entity referring part 132. The entity referring unit 130 searches the database unit 150 on the basis of the definition of the variable received from the variable converting unit 120 and performs an entity referring process.

The database unit 150 is constructed by a template database part 151 and a variable-content database part 152. The template database part 151 is an area for holding document data which is not influenced by the parameter information. The variable-content database part 152 is an area for holding database components 153 with tags managed in the state of a plurality of files. The variable-content databas part 152 holds data with a tag, which is influenced by the parameter information in each of the files of the database components 153 with tags.

The synthesizing unit 140 is a layouter for laying out the data with tags and physically instantiating the definition of entity reference in a manual 160 to be output. In this case, application software called “FrameMaker+SGML”, which is the trademark of Adobe Systems Incorporated, is used.

The manual 160 obtained by instantiating variables (the character train variable and the data variable with a tag) embedded in a template document in the template database part 151 and performing synthesis is output.

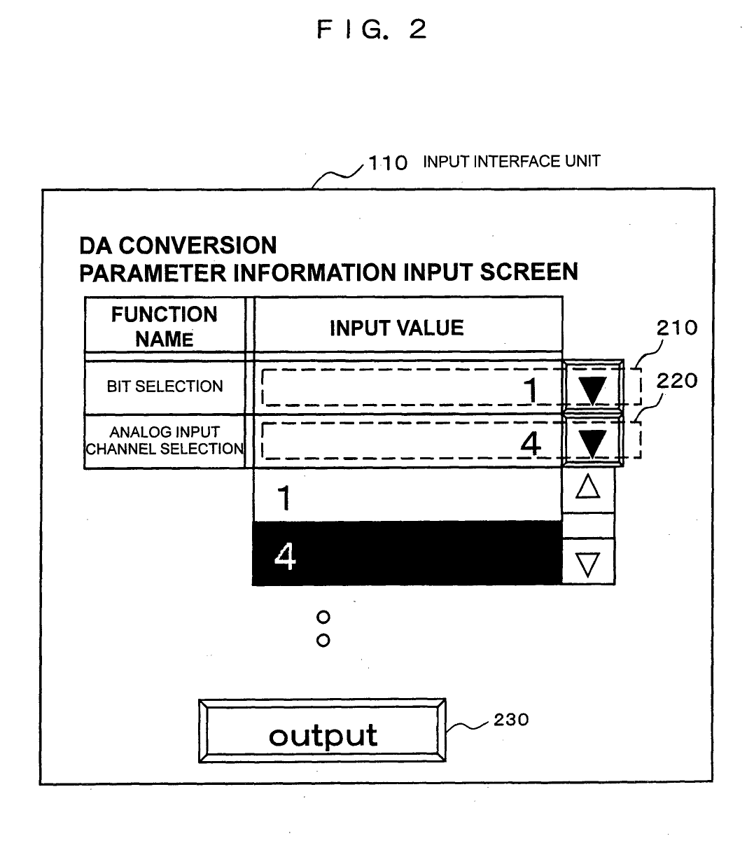

The input interface unit 110, variable converting unit 120, entity referring unit 130, template database part 151, variable-content database part 152, synthesizing unit 140, and manual 160 are described below with reference to FIGS. 2, 3, 4, 5, 6, and 7, respectively.

FIG. 2 shows an example of the display screen in the input interface unit 110. An example of “function of D/A conversion” as one of chapters of the manual of a microcomputer is shown here. An input part of parameter information by a designer is constructed by “function name” and “input value”. In the example, parameter information of “BIT selection” and “analog input channel selection” is used. For the function name of “BIT selection”, as an input value 210 of BIT selection, either a numerical value “0” or “1” is selected from a list. For the function name of “analog input channel selection”, as an input value 220 of analog input channel selection, a numerical value “1” or “4” is selected from a list.

Although only the input values in the list forms are shown in FIG. 2, a pattern of a format in which a word can be directly input can also be provided.

An output button 230 is a button for outputting the definition of a variable to the entity referring unit 130 via the variable converting unit 120. Specifications of a program of the configuration of the display screen in FIG. 2 and input of a list format are created by using a function of an application software, “Excel”. “Excel” is a trademark of Microsoft Corporation.

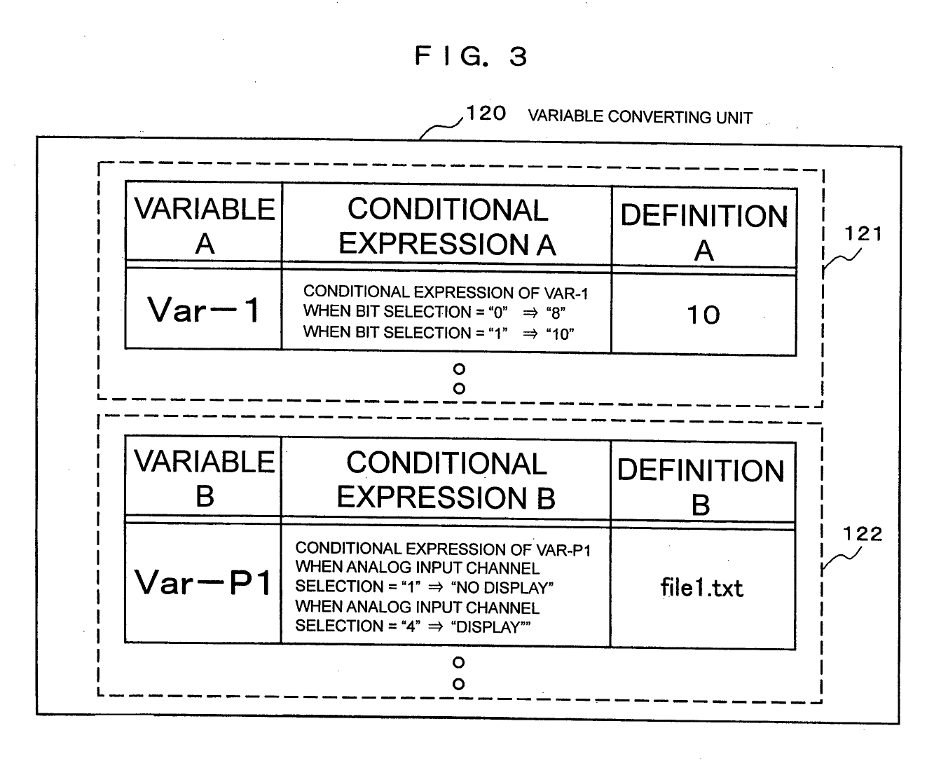

FIG. 3 shows an example of a table in the variable converting unit 120.

The character train variable converting part 121 is constructed by a variable A, a conditional expression A, and a definition A. The line of the variable A is a line indicative of the variable name of definition of a character train variable. The line of the conditional expression A is a line for determining the value of the definition A for the variable A. The conditional expression A is a part in which a definition is made by using the parameter information of FIG. 2 as a condition, information added to the input information is used as a definition, a calculation value of a numerical value is used as a definition, and search and extraction are performed in accordance with information. The line of the definition A is a line indicative of the definition for the variable A generated by the conditional expression A.

A first item of the character train variable converting part 121 has “Var-1”, “conditional expression of Var-1”, and “definition of Var-1”. “Var-1” is a variable name of the character train. The “conditional expression of Var-1” is “when BIT selection=“0”→“8” and when BIT selection=“1”→“10” ”. This is the expression on the display screen, which is internally constructed by a program of conditional branch.

In “definition of Var-1”, the input value 210 of BIT selection in FIG. 2 is applied to the “conditional expression of Var-1” and the result of conditional branch of the internal program is read. In the case where the numerical value “0” is input as the input value 210 of BIT selection, “8” is given as the “definition of Var-1”. When the numerical value “1” is input as the input value 210 of BIT selection, “10” is given as the “definition of Var-1”. FIG. 3 illustrates the case of “10”.

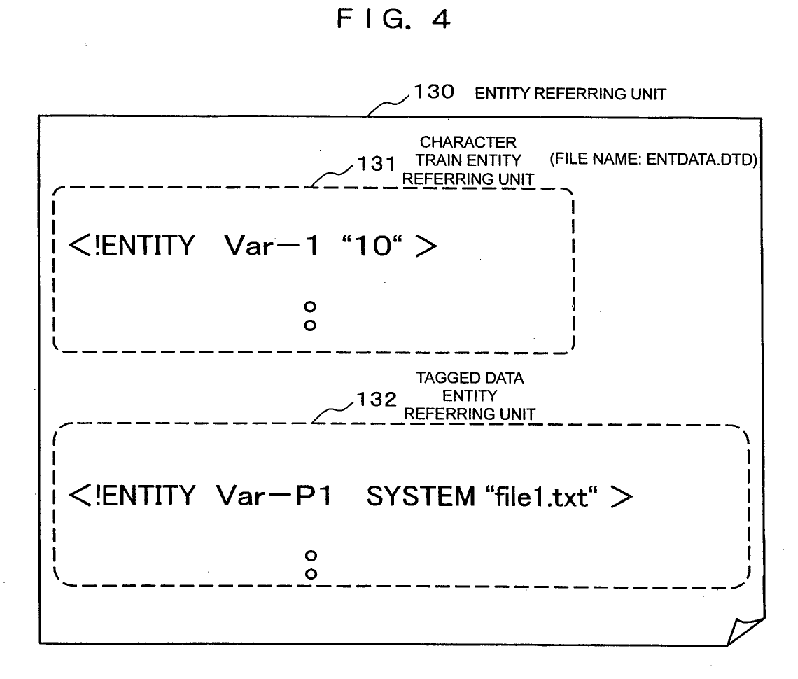

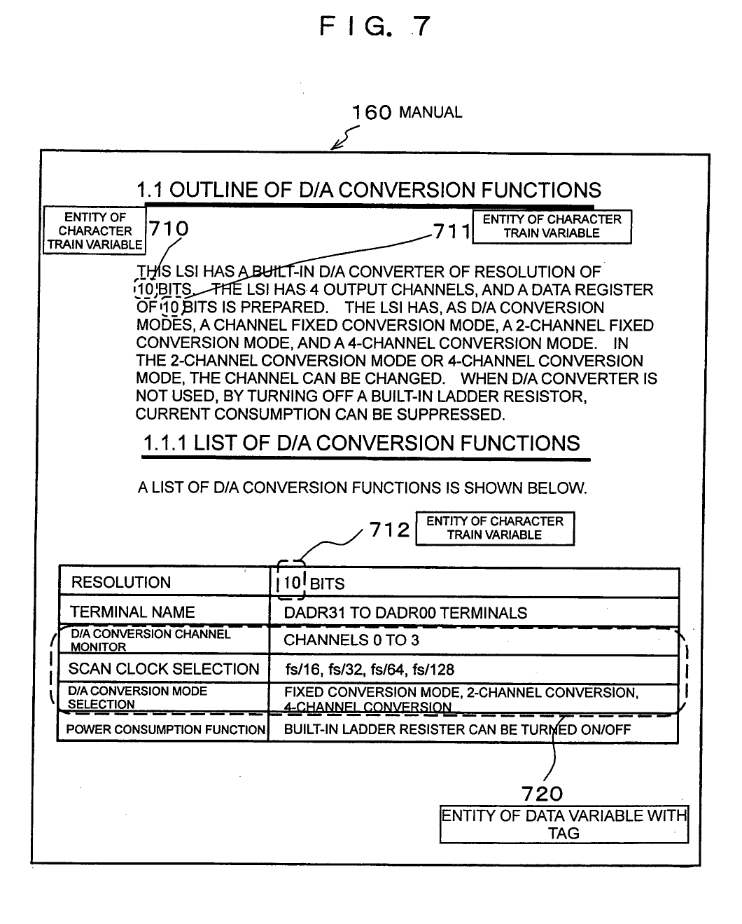

“10” as an example will be reflected in the character train entity referring part 131 in the entity referring unit 130 in FIG. 4 and will also be reflected in character lines 710, 711, and 712 in the manual 160 in FIG. 7 which will be described later.

The tagged data variable converting part 122 is constructed by a variable B, a conditional expression B, and a definition B. The line of the variable B is a line indicative of the variable name of the definition of a data variable with a tag. The conditional expression B is a line for determining the value of the definition B of the variable B. The conditional expression B is a portion in which a definition is made by using the parameter information of FIG. 2 as a condition, information added to the input information or a calculation value of a numerical value is used as a definition, and search and extraction are performed in accordance with information. The definition B is a line indicative of the definition of the variable B generated by the conditional expression B. The difference between the definition A and the definition B is that either a character line is used or a relative path of data with a tag is used.

A first item of the tagged data variable converting part 122 has “Var-P1”, “conditional expression of Var-P1”, and “definition of Var-P1”. “Var-P1” is a data variable name with a tag. The “conditional expression of Var-P1” is “when analog input channel selection=“0”→“no display” and when analog input channel selection=“4”→“display” ”. This is the expression on the display screen, which is internally constructed by a program of conditional branch.

In “definition of Var-P1”, the input value 220 of analog input channel selection in FIG. 2 is applied to the “conditional expression of Var-P1” and a result of conditional branch by the internal program is read. In the case where the numerical value “4” is input as the input value 220 of analog input channel selection, an instruction “file1.txt” of a relative path for displaying the database component 153 with a tag on the template database part 151 is given. When the numerical value “1” is input as the input value 220 of analog input and channel selection, an instruction “ ” (blank) which does not display the database component 153 with a tag on the template database unit 151 is given. FIG. 3 illustrates the case of “file1.txt”.

The path in the example is in the position of a relative path of a file seen from the template database part 151. For a path in the case where a database component with a tag is stored in a folder, it is sufficient to employ the configuration of “folder nameyfile1.txt” including the path of the folder name.

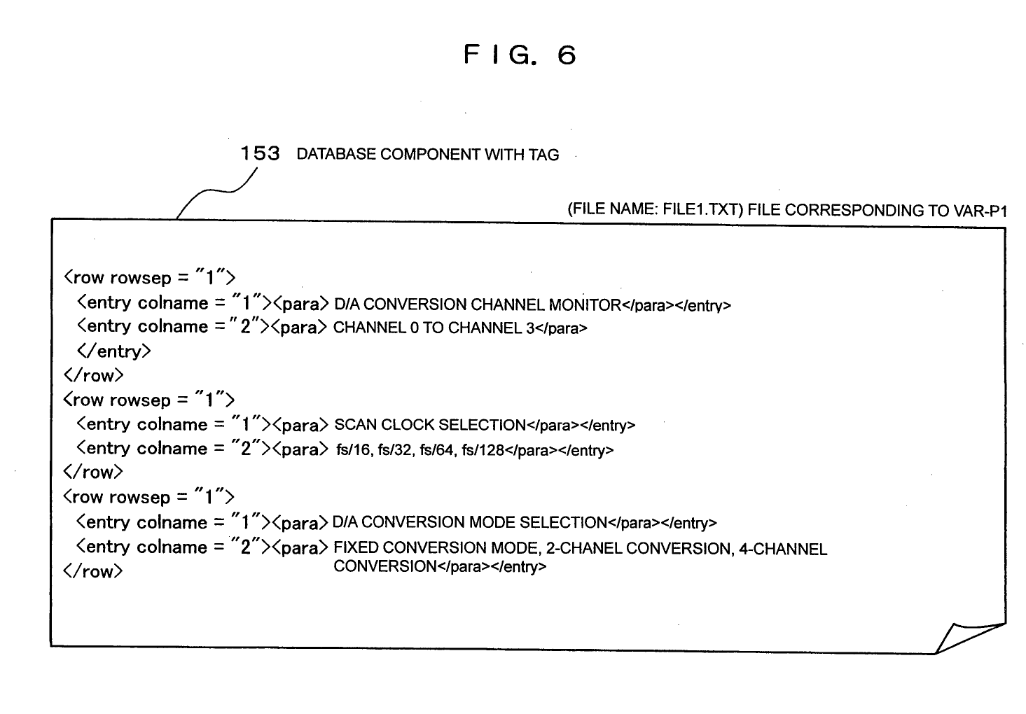

“file1.txt” of the example is reflected in the tagged data entity referring part 132 in the entity referring unit 130 in FIG. 4 which will be described later. It is also reflected in the database component 153 with a tag in FIG. 6 and an entity 720 of a data variable with a tag in the manual 160 of FIG. 7 which will be described later.

Specifications of the program of the display screen configuration, the conditional expressions, and the like in FIG. 3 are generated by using functions of the application software “Excel”.

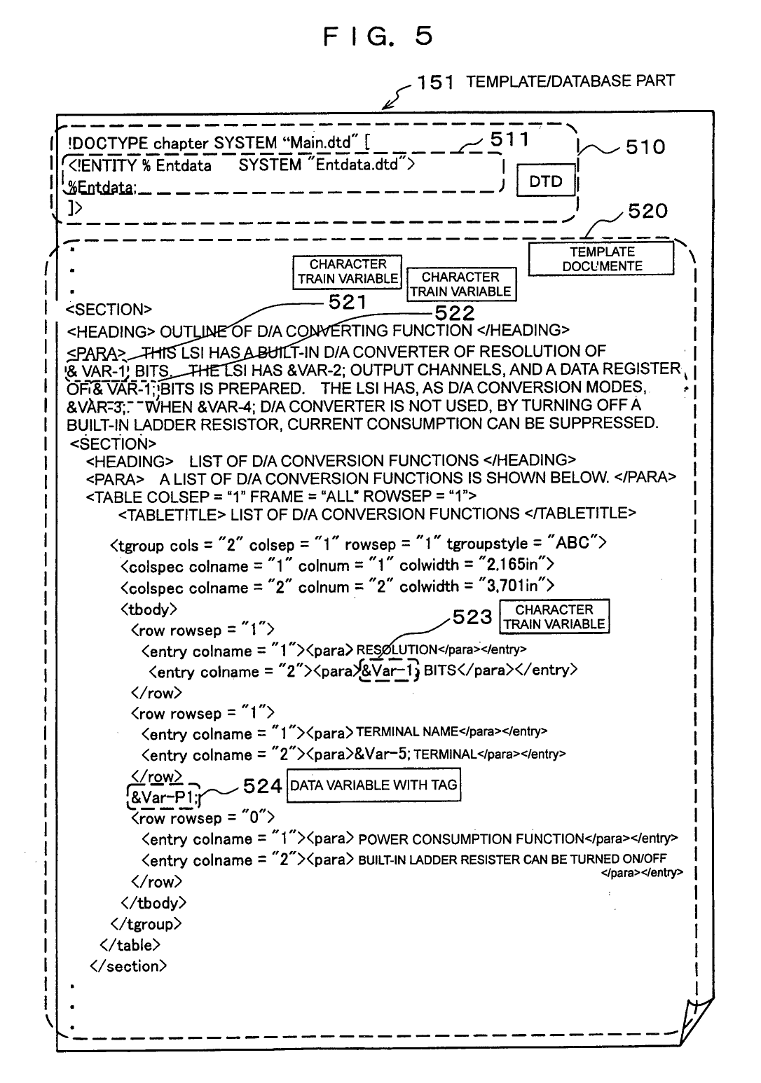

FIG. 4 shows an example of data processed by the entity referring unit 130. The data is a result of conversion by the variable converting unit 120 performed when the designer clicks the output button 230 in the input interface unit 110. The result is displayed on the screen. The data of FIG. 4 also corresponds to the data of a subset 511 (refer to FIG. 5) of DTD (Document Type Definition) of the template database part 151.

In the character train entity referring part 131, “Var-1” is a variable name and “definition of Var-1” is the definition of a character train for the variable name. The character train entity referring part 131 is one of the definitions described in DTD of an SGML document.

SGML (Standard Generalized Markup Language) is used to define a document structure and to map the data of the document. DTD (Document Type Definition) is used as a rule of the order of adding marks at the time of tagging data.

In the embodiment, in the case of a definition <!ENTITY Var-1 “10” >, by substituting character train variables 521, 522, and 523 of “Var-1” in a template document (document of data with a tag) 520 (refer to FIG. 5), the variables are consequently instantiated with the character train of “10” (refer to FIG. 7).

In the tagged data entity referring part 132, “Var-P1” is a variable name. “Definition of Var-P1” is the definition of the positional relation of relative paths of the template database part 151 and the variable-content database part 152. The relation is associated by the tagged data of “Var-P1”.

The tagged data entity referring part 132 is one of definitions described in DTD in an SGML document. In the embodiment, in the case of a definition <!ENTITY Var-P1 SYSTEM“file1.txt” >, when a data variable 524 with a tag of “Var-1” is substituted in the template document 520 (refer to FIG. 5), the variable is consequently instantiated with the data with a tag in the file “file1.txt” in the template database part 151 (refer to FIG. 7).

FIG. 5 shows an example of data to be processed by the template database part 151 in FIG. 1. The data is described in an SGML document constructed by DTD 510 and the template document 520. The template database part 151 is a database with a tag central to the system. The template database part 151 includes the DTD 510 defining regularity of the template document 520. The DTD 510 determines regularity of the template document 520. The subset 511 of the DTD 510 can add regularity of the template document 520 to the DTD 510 and can call definition of the entity referring unit 130 shown in FIG. 4.

In the template document 520, the character train variables “Var-1” and the data variable “Var-P1” with a tag are embedded. The variables “Var-1” and the data variable “Var-P1” with a tag embedded will be instantiated in the manual 160 of FIG. 7 which will be described later.

To call a variable in the template document 520, it is sufficient to sandwich the variable with “&” and a semicolon “;”. 521 denotes a character train variable of “Var-1”. 522 and 523 denote similar character train variables of “Var-1”. 524 denotes the data variable with a tag of “Var-P1”.

FIG. 6 shows an example of the database component 153 with a tag in the variable-content database part 152 in FIG. 1. In the embodiment, the tagged database component 153 is a file called by the variable of “Var-P1”. The file is reflected as the entity 720 of the tagged data variable of FIG. 7 which is described below.

FIG. 7 shows the manual 160 in FIG. 1 and an example which is obtained by synthesis of the synthesizing unit 140 and is output. The manual 160 is laid out by the function of “FrameMaker+SGML” of the synthesizing unit 140.

In the manual 160, “Var-1” of the character train variables 521, 522, and 523 in the template document 520 in FIG. 5 is instantiated and reflected as “10” of the character trains 710, 711, and 712. “Var-P1” of the tagged data variable 524 in the template document 520 in FIG. 5 is reflected as the file 720 instantiated via a file formed by the tagged database component 153 of FIG. 6. As the file of FIG. 6, a table creation file having items of “D/A conversion channel monitor”, “channels 0 to 3”, “scan clock selection”, “fs/16, fs/32, fs64, fs/128”, “D/A conversion mode selection”, and “fixed conversion mode, 2-channel conversion, 4 channel conversion” is described. The file is finished as a concrete table in the manual 160 in FIG. 7. A plurality of files each having such a complicated structure are stored as the tagged database components 153 in the variable data database unit 152.

The flow of the series of processes can be summarized as follows.

When “1” is set in “BIT selection” in the input interface unit 110 shown in FIG. 2, “10” is set as “definition of Var-1” by the character train variable converting part 121 in the variable converting unit 120 shown in FIG. 3, the character train entity referring part 131 in the entity referring unit 130 shown in FIG. 4 is formed, on the basis of the character train entity referring part 131, the template document 520 in the template database part 151 shown in FIG. 5 is read, “10” of “definition of Var-1” in the character train entity referring part 131 is instantiated with respect to the character line variables 521, 522, and 523 in the template document 520, and “10” is reflected in the character trains 710, 711, and 712 in the manual 160 shown in FIG. 7.

When “4” is set in “analog input channel selection” in the input interface unit 110 shown in FIG. 2, “file1.txt” is set as “definition of Var-P1” by the tagged data variable converting part 122 in the variable converting unit 120 shown in FIG. 3, the tagged data entity referring part 132 in the entity referring unit 130 shown in FIG. 4 is formed and, on the basis of the tagged data entity referring part 132, the database component 153 with a tag shown in FIG. 6 is read into the template document 520 in the template database part 151 shown in FIG. 5. “file1.txt” as the “Var-P1 definition” in the tagged data entity referring part 132 is instantiated for the data variable 524 with a tag in the template document 520 and is reflected in the entity 720 of the data variable with a tag in the manual 160 shown in FIG. 7.

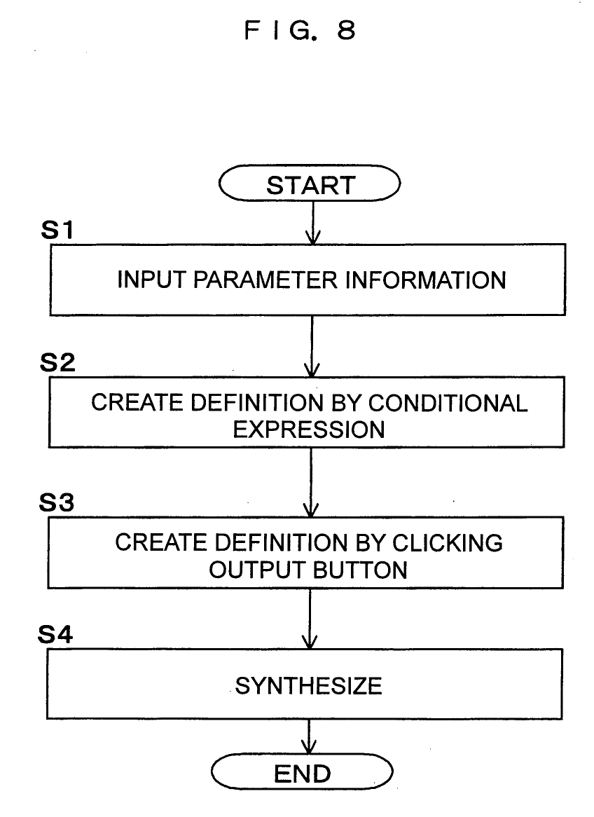

The operation of automatic creation of the manual of the embodiment constructed as described above is described in accordance with the flowchart of FIG. 8.

In step S1, a process of inputting parameter information of “DA conversion” is performed. The parameter information is input by the designer with a keyboard or the like. Concretely, the numerical value “1” is input as the input value 210 of BIT selection and the numerical value “4” is input as the input value 220 of the analog input and channel selection (refer to FIG. 2).

In step S2, on the basis of the input parameter information of the “DA conversion”, the variable converting unit 120 generates the definition “10” of the variable of “Var-1”. The variable of “Var-P1” creates definition of a path of data of the database component 153 with a tag as the file “file1.txt”.

In step S3, by clicking the output button 230, the definition is output in the description format of DTD in the entity referring unit 130.

In step S4, the entity referring unit 130 gives the definition of the variable to the database unit 150, synthesis is made by the synthesizing unit 140, and the variable is instantiated. The variable “Var-1” is instantiated with “10”. The file “file1.txt” of “Var-P1” is also instantiated.

In the output manual 160, the variables “Var-1” are instantiated with “10” and the variable “Var-P1” is instantiated as the database component with a tag.

Although a character train or a data variable with a tag is not placed in the tagged database component 153 in the foregoing embodiment, a character train or a data variable with a tag may be nested in the tagged database component 153.

As described above, according to the embodiment, only by inputting parameter information, a manual can be automatically created flexibly in accordance with a change in specifications.

Although creation of a manual of “the chapter of DA conversion function” as one of the functions of a microcomputer at the time of creating a manual according to specifications has been described as an example, obviously, a manual of a timer function or an I/O port function can be also created. Also at the time of creating the whole manual of a microcomputer, the principle is the same. Further, the invention is not limited to a manual of a microcomputer but can sufficiently deal with creation of a manual according to specifications. By automatically creating a manual, the number of processes for creation of a manual can be largely reduced.

According to the invention as described above, since the database unit is constructed by a combination of the template database part and the variable-content database part, unlike the conventional technique, it is unnecessary to set all of the elements constructing a document as components. Thus, a database can be simplified. Further, only by inputting parameter information as information of a part to be changed in accordance with a change in specifications, the invention can flexibly deal with not only a simple character train, but also data with a tag such as a document, a table, or a figure having a more complicated structure. Therefore, a document creation support can be made efficiently.

Particularly in automatic creation of manuals of various new products and, what is more, a high technology product requiring complicated operations and much knowledge, the effects of the invention are maximally displayed. A large reduction in the number of processes required to create a manual can be realized.

From the above description, it is apparent what the present invention provides.

What is claimed is:

1. A document creation support system comprising:
a database unit constructed by a template database part including document information of a template document in which a character train variable and a data variable with a tag are embedded, and a variable-content database part including a group of database components with tags;
an input interface unit for inputting parameter information instructing a description change part in a target document with respect to the template document;
a variable converting unit for defining the character train variable and the data variable with a tag on the basis of the input parameter information;
an entity referring unit for searching the template database part and the variable-content database part on the basis of the character train variable and the data variable with a tag; and
a synthesizing unit for instantiating the character train variable in the template document retrieved by the search with the definition of the character train variable, instantiating the data variable with a tag in the template document with the tagged database component retrieved by the search, and synthesizing the resultants, thereby creating a target document.

2. The document creation support system according to claim 1, wherein the database component with a tag in the variable-content database part has a nested structure in which a character train variable and a data variable with a tag are embedded.
